(19) United States
(12) Patent Application Publication
(10) Pub. No.: US 2011/0174270 A1
(43) Pub. Date: Jul. 21, 2011

(54) PRESSURE RELIEF VALVE

(75) Inventors: Burkhard HARHOFF, Bielefeld (DE); Karsten ANGER, Paderborn (DE); Christian RABE, Marienfeld (DE)

(73) Assignee: POPPE & POTTHOFF GMBH, Werther (DE)

(21) Appl. No.: 13/006,211

(22) Filed: Jan. 13, 2011

(30) Foreign Application Priority Data
Jan. 20, 2010 (DE) 10 2010 005 101.2

(51) Int. Cl. F02M 61/20; F16K 17/00; B21K 1/20

(52) U.S. Cl. 123/456; 137/511; 29/890.124

(57) ABSTRACT

A pressure relief valve suitable for limiting fluid pressure in a common rail of a fuel injection system comprises a first housing part having a first through-bore with a first segment, a second segment and the valve seat defined therebetween. A second housing part is screw fastened with the first housing part and includes a second through-bore disposed coaxially to the first through-bore. An overall rod-shaped valve member is axially displaceable within the second segment. A spring biases the valve member towards the valve seat. A portion of the valve member opposite of the valve seat includes a shaft having a terminal end formed with a non-round cross-section configured such that a tool inserted through the second through-bore and engaging the non-round cross-section prevents the terminal end, and thus the valve member, from rotating relative to the first housing part when the first and second housing parts are screwed together.

### CROSS-REFERENCE

This application claims priority to German patent application no. 10 2010 005 101.2 filed on Jan. 20, 2010, the contents of which are fully incorporated herein by reference.

### TECHNICAL FIELD

The present invention generally relates to a pressure relief valve, which may be used in certain embodiments to limit the fluid pressure in a distributor pipe of a common rail fuel injection system.

### BACKGROUND ART

Common rail systems are utilized to distribute fuel under high-pressure to a plurality of fuel injectors of an engine, such as a diesel engine. Such common rail systems typically include a pressure relief valve or safety valve that prevents the pressure within the common rail from exceeding a predetermined threshold, at which damage could result to the distributor pipe (common rail) or other components in fluid communication therewith.

DE 198 22 671 A1 and its English-counterpart U.S. Pat. No. 6,244,253 disclose a pressure relief valve comprising a first housing part screw-fastened together with a second housing part. A spring is supported between the second housing part and a valve member that is movably disposed within the first housing part. When assembling this pressure relief valve by screwing the second housing part into the first housing part, the spring will apply a torque to the valve member, which tends to cause the valve member to rotate about its axis during the screw-fastening step. This relative rotation may severely stress the contact between the valve member and the valve seat, which can impair the sealing of the valve member against the valve seat during subsequent operation of the pressure relief valve.

JP 2003-322265 discloses a pressure relief valve that includes a valve seat in a first housing part and a pipe guide in a second housing part. The first and second housing parts are screwed together. A shaft of a valve member is guided in the pipe guide and a spring biases the valve member into sealing abutment on the valve seat.

### SUMMARY

It is an object of the present teachings to disclose an improved pressure relief valve, which preferably may be utilized as a safety valve for a distributor pipe or common rail of a high-pressure fuel injection system.

In one aspect of the present teachings, the pressure relief valve includes a valve member having a structure configured to prevent the valve member from being rotated against a valve seat during assembly of the pressure relief valve, e.g., in conjunction with a tool engaging or rotationally-fixing the structure during assembly of the pressure relief valve. This design has the advantage of preventing damage to the valve member and/or the valve seat that could impair the valve sealing capabilities of the pressure relief valve during operation.

In another aspect of the present teachings, the structure preferably has a non-round, e.g., at least partially flat, and/or slot-shaped cross-section in the radial direction. Such a structure enables a tool inserted into the pressure relief valve during assembly to reliably engage and prevent relative rotation of the structure and thus the valve member while a second housing part is being rotated, e.g., screw fastened, relative to a first housing part that defines the valve seat.

Further objects, features and advantages of the present teachings will become apparent to the skilled person upon reading the following description and claims in conjunction with the appended drawings.

### BRIEF DESCRIPTION OF THE DRAWINGS

FIG. 1 shows a longitudinal cross-section through a pressure relief valve according to the present teachings.

FIG. 2 shows a portion of the pressure relief valve of FIG. 1 in an enlarged view.

### DETAILED DESCRIPTION OF THE INVENTION

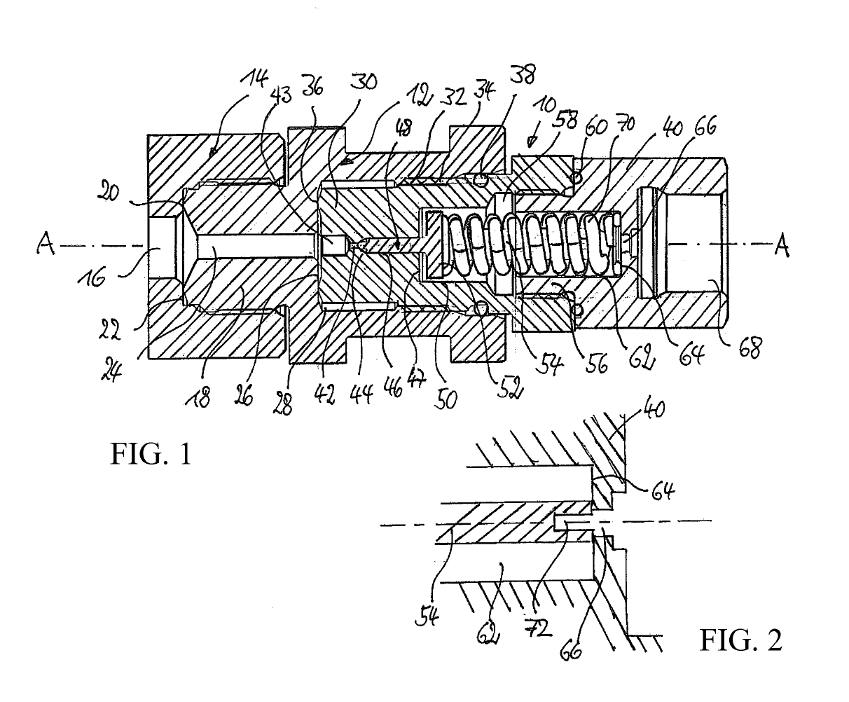

Referring to FIG. 1, a pressure relief valve is identified as a whole with 10 and is connected via an adapter 12 with a distributor pipe (common rail) 14 of a common rail fuel injection system. Because the construction and function of common rail fuel injection systems are well known, a detailed description of common rail fuel injection systems is not necessary.

The distributor pipe 14 includes a stepped connection bore 16, which opens towards the left side of FIG. 1 into the interior of the distributor pipe 14 that is subjected to high pressure. An extension 18 of the adapter 12 projects into a widened segment of the connection bore 16 and is screw-fastened with it. An annular edge 20 (also known as an annular knife edge) is formed on a front end surface of the extension 18 and the annular edge 20 comes into sealing abutment with the distributor pipe 14 at a step 22 of the annular bore when the adapter 12 is screw-fastened into the connection bore 16. When the adapter 12 is attached to the distributor pipe 14, a through-bore 24 of the adapter 12 is connected with the connection bore 16 in a fluid-tight sealed manner relative to the outside via the annular edge 20.

The through-bore 24 of the adapter 12 transitions via a step 26 into a widened segment 28. A first housing part 30 of the pressure relief valve 10 projects into the widened segment 28. The first housing part 30 has an outer thread 32 that can be screw-fastened with an inner thread 34 of the adapter 12, such that an annular edge (annular knife edge) 36 formed on the front end side of the first housing part 30 is pressed against the step 26 of the through-bore 24 of the adapter 12 in sealing abutment. For additional sealing, a sealing ring 38 is provided between the terminal end portion of the adapter 12 and the first housing part 30.

The first housing part 30 has a stepped through-bore that will be further described in the following. This through-bore communicates with another through-bore of a second housing part 40 of the pressure relief valve 10, as will be further described below. All mentioned through-bores are disposed coaxially to a central axis A-A of the described assembly.

The through-bore of the first housing part 30 includes a first segment 42 defined at a junction to an inlet segment 43 of the first housing part 30. The inlet segment 43 opens towards and is in fluid communication with the through-bore 24. The first segment 42 of the through-bore transitions into a wider-diameter second segment 46 via a preferably chamfered step forming a valve seat 44. The second segment 46 transitions via a step 47 into a third segment 50 having a further widened diameter.

An overall rod-shaped valve member 48 is movably guided in the second segment 46. The valve member 48 ends in a needle or a point on the left side according to FIG. 1 and the needle or point is pushable into sealing abutment against the valve seat 44. The valve member 48 includes an annular flange 52 having a widened diameter on the end of the valve member 48 opposite of the needle/point. A shaft 54 axially extends from the flange 52 in the direction opposite of the needle, i.e. opposite of the valve seat 44.

A projection 56 of the second housing part 40 extends into a fourth widened segment 58 of the through-bore of the first housing part 30 and has an outer thread that is screw-fastened with an inner thread of the fourth segment 58. For additional sealing, a sealing ring 60 is disposed between an end side of the first housing part 30 and a collar of the second housing part 40.

The through-bore of the second housing part 40 includes a first segment 62 that transitions via a step 64, which is preferably perpendicular to the axis A-A, into a second segment 66 having a reduced diameter. The second segment 66, in turn, transitions directly or via an intermediate step into a third segment 68 having a widened diameter.

In FIG. 1, the valve member 48 is disposed in the closed state, i.e. the valve member 48 sealingly abuts on the valve seat 44, and the shaft 54 extending from the valve member 48 projects into the first segment 62 of the through-bore of the second housing part 40. Further, the shaft 54 is surrounded by a spring 70, which is supported on one axial end by the annular flange 52 of the valve member 48 and is supported on the other axial end by the step 64 of the through-bore of the second housing part 40. Thus, the spring 70 biases the valve member 48 in the leftward direction according to FIG. 1, so that the valve member 48 normally contacts the valve seat 44 in a sealed manner, thereby preventing release of fluid from the distributor pipe 14.

Consequently, when the valve member 48 is lifted from the valve seat 44 due to the force of the high-pressure fluid within the distributor pipe 14 exceeding the spring force of spring 70, high-pressure fluid can escape in order to release excess pressure in the interior of the distributor pipe 14. For example, at least one axial channel or groove may be formed between the axially-extending outer surface of the valve member 48 and the opposing axial-extending surface of the second segment 46 of the through-bore of the first housing part 30. In this case, high-pressure fluid can flow through the at least one axial channel into the third segment 50 when the valve member 48 is moved to the right and does not sealingly contact the valve seat 44, and from there into the through-bore of the second housing part 40. The fluid can then be discharged from there towards the right according to FIG. 1 into a return line (not illustrated) connected to the third segment 68.

FIG. 2 shows a portion of FIG. 1 in an enlarged view in the vicinity of the second segment 68 of the through-bore of the second housing part 40. The spring 70 has been omitted for purposes of clarity. In FIG. 2, the valve member 48 is in the fully-opened position and the valve opening movement is limited by abutment of an end surface of the shaft 54 on the step 64, which forms a stop. As is further apparent in FIG. 2, a slot 72 is defined in the end surface of the shaft 54 and the slot 72 provides a fluid passage when the shaft 54 is abutting against the step 64. Thus, high-pressure fluid can flow through the passage provided by the slot 72 from the first segment 62 of the through-bore into the second segment 66.

The pressure relief value 10 may optionally be assembled in the following non-limiting manner.

The valve member 48 is first inserted into the second segment 46 of the through-bore of the first housing part 30. The spring 70 is then pushed onto the shaft 54 until it abuts on the annular flange 52. The second housing part 40 is screwed into the first housing part 30 with the sealing ring 60 intervening therebetween, until the sealing ring 60 achieves a secure seal between the first and second housing parts 30, 40.

While the second housing part 40 is being screwed onto the first housing part 30, a tool, e.g., a screwdriver, is inserted through the third segment 68 and the second segment 66 of the through-bore of the second housing part 40 and engages in the slot 72. In addition, the outer contour of the second housing part 40 is preferably formed so that it can be rotated by a corresponding tool, e.g., a wrench. Therefore, while the wrench is used to rotate the second housing part 40, the screwdriver holds the shaft 54 so that it is rotatably-fixed relative to the first housing part 30, i.e. so that the valve member 48 does not rotate relative to the first housing part 30 during the screwing-in of the second housing part 40.

Then, the pressure relief valve 10 is screwed together with the adapter 12 (if the first housing part 30 was not previously screwed together with the adapter 12). Thereafter, the adapter 12 is screwed into the distributor pipe 14.

If the first housing part 30 is formed such that it can be directly screwed together with the distributor pipe 14, the adapter 12 can be completely omitted.

The various components are axial dimensioned such that, when the valve member 48 abuts on the valve seat 44, a small clearance exists between the annular flange 52 and the step 47 and a small clearance exists between the end surface of the shaft 54 and the step 64 of the through-bore of the second housing part 40, thereby defining a range of axial movement of the valve member 48 during operation. When a sufficiently-high fluid pressure is present in the first segment 42 of the through-bore of the first housing part 30, the force of the spring 70 will be overcome and the valve member 48 will move rightward. The rightward, opening movement is limited by the end surface of the shaft 54 contacting the step 64.

The above-described assembly can be modified in a variety of ways:

For example, the right (terminal) end portion of the shaft 54 according to FIG. 2 can be formed with any non-round cross-section, so that the shaft 54 can be held in a rotatably-fixed manner by a tool that surrounds it. Thus, in addition to or instead of the slot 72, the outer circumference of the shaft 54 may be polygonal, e.g., triangular, square, pentagonal, hexagonal, octagonal, etc., and the tool may be, e.g., a socket wrench having a corresponding shape for securely retaining the shaft 54. If the terminal end of the shaft 54 is formed with an exterior, at least partially non-round shape, but without the slot 72, then the step 64 and second segment 66 may be designed so that radially outer edges of the shaft 54 abut the step 64 in the valve opened position and fluid can pass along one or more axial grooves (which may also serve as tool-engaging grooves during the assembly process) on the circumference of the shaft 54 into the second segment 66.

In addition or in the alternative, the slot 72 can be formed as a crossed slot (e.g., a “Phillips” head), or it can be formed in the shape of a central opening having a non-round cross-section, from which at least one channel or groove leads to the outer side of the shaft 54. In this case, the non-round cross-section may again be polygonal, e.g., triangular, square, pentagonal, hexagonal, octagonal, etc., and the tool for retaining the shaft 54 may be, e.g., a screw driver having a corresponding head shape or more particularly, a hex key or Allen wrench for hexagonal slots.

The pressure relief valve 10 is not required to be formed so that fluid flows out of the pressure relief valve 10 in the axial direction. Instead, a radial bore can be defined in the pressure relief valve 10 that leads radially outwardly from the through-bore of the first housing part 30 in the area of its second or third segment. The radial bore may be connected with a discharge opening leading radially out from the first housing part 30 or the adapter 12. The second segment 66 of the through-bore of the second housing part 40 is then connected in a fluid-tight manner after mounting of the pressure relief valve 10 on the distributor pipe 14.

The spring 70 is not required to be supported directly on the step 64 that forms the stop for the shaft 54 in the illustrated exemplary embodiment. Instead, one or more intervening rings or washers can be disposed between the spring 70 and the step 64 and the biasing force of the spring 70 may be adjusted by the intervening ring(s).

The two housing parts may instead be attached to each other by providing first housing part 30 with an outer thread and by providing the second housing part 40 with an inner thread.

Although the invention was exemplified in detail in accordance with a pressure relief valve that may be used as a safety valve in a common rail fuel injection system, the present teachings are not limited to such applications and the pressure relief valves may be used in any appropriate application thereof.

A representative, non-limiting example of the present invention was described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved pressure relief valves and methods for manufacturing the same.

Moreover, combinations of features and steps disclosed in the above detail description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

### REFERENCE NUMBER LIST

10 Pressure relief valve
12 Adapter
14 Distributor pipe (common rail)
16 Connection bore
18 Extension
20 Annular edge
22 Step
24 Through-bore
26 Step
28 Widened segment
30 First housing part
32 Outer thread
34 Inner thread
36 Annular edge
38 Sealing ring
40 Second housing part
41 First segment
43 Inlet segment
44 Valve seat
46 Second segment
47 Step
48 Rod-shaped valve member
50 Third segment
52 Annular flange
56 Projection
58 Fourth segment
60 Sealing ring
62 First segment
64 Step
66 Second segment
68 Third segment
70 Spring
72 Slot

1. A pressure relief valve suitable for limiting fluid pressure in a distributor pipe of a common rail fuel injection system, comprising:
a first housing part having a first through-bore and a valve seat defined therein, the through-bore comprising:
a first segment configured to be in fluid communication with the fluid pressure in the distributor pipe, and
a second segment having a larger diameter than a diameter of the first segment, the valve seat being defined between the first segment and the second segment,
a second housing part having a second through-bore disposed coaxially to the first through-bore, wherein one of the first housing part and the second housing part has an outer thread and the other of the first housing and the second housing part has an inner thread that is screw-fastened with the outer thread,
an overall rod-shaped valve member that is axially displaceable within the second segment of the first through-bore, and
a spring biasing the valve member towards the valve seat and being supported between the valve member and a step defined in the second through-bore such that fluid discharge from the first segment to the second segment is blocked when the valve member sealingly abuts the valve seat,
wherein a portion of the valve member opposite of the valve seat includes a shaft having a terminal end formed with a non-round cross-section configured such that, during screwing-together of the first and second housing parts, the terminal end is retainable in a rotatably-fixed manner relative to the first housing part by a tool inserted through the second through-bore.

2. A pressure relief valve according to claim 1, wherein the valve member is guided by the second segment.

3. A pressure relief valve suitable for limiting fluid pressure in a distributor pipe of a common rail fuel injection system, comprising:
a first housing part having a first through-bore and a valve seat defined therein, the first through-bore comprising:
a first segment configured to be in fluid communication with the fluid pressure in the distributor pipe, and
a second segment having a larger diameter than a diameter of the first segment, the valve seat being defined between the first segment and the second segment,
a second housing part having a second through-bore disposed coaxially to the first through-bore, wherein one of the first housing part and the second housing part has an outer thread and the other of the first housing and the second housing part has an inner thread that is screw-fastened with the outer thread,
an overall rod-shaped valve member that is axially displaceable within the second segment of the first through-bore, and
a spring biasing the valve member towards the valve seat and being supported between the valve member and a step defined in the second through-bore such that fluid discharge from the first segment to the second segment is blocked when the valve member sealingly abuts the valve seat,
wherein a portion of the valve member opposite of the valve seat includes a shaft having a terminal end formed with a slot configured such that, during screwing-together of the first and second housing parts, the terminal end is retainable in a rotatably-fixed manner relative to the first housing part by a tool inserted through the second through-bore.

4. A pressure relief valve according to claim 3, wherein the end surface of the shaft abuts on a step in an opened position of the valve member and a second segment of the second through-bore penetrates through a center of the step such that the slot forms a fluid passage for discharging fluid when the valve member is in the opened position.

5. A pressure relief valve according to claim 4, wherein the spring surrounds the shaft and is supported on the step that limits the movement of the valve member in a valve opening direction.

6. A pressure relief valve according to claim 5, wherein the valve member is guided by the second segment.

7. A pressure relief valve according to claim 3, wherein the valve member is guided by the second segment.

8. A pressure relief valve comprising:
a first housing part having a first through-bore with a first axial bore segment, a second axial bore segment and a valve seat defined therebetween,
a second housing part having a second through-bore disposed coaxially to the first through-bore, the second housing part being thread-fastened with the first housing part,
a substantially rod-shaped valve that is axially displaceable within the second axial bore segment and sealingly abuts on the valve seat in a valve closed position, and
a spring biasing the valve towards the valve seat,
wherein the valve includes a shaft on an end opposite of the valve seat and at least a portion of a radial cross-section of the shaft end is configured to be securely engaged by a tool during assembly of the pressure relief valve, such that engagement of the tool with the shaft end prevents the valve from rotating relative to the first housing part when the first and second housing parts are being screwed together.

9. A pressure relief valve according to claim 8, wherein the shaft end includes one of a single slot and a crossed slot.

10. A pressure relief valve according to claim 8, wherein the portion of the radial cross-section configured to be securely engaged by the tool during assembly of the pressure relief valve includes at least one planar edge.

11. A pressure relief valve according to claim 8, wherein the spring is supported between a flange defined on the valve and a step defined in the second through-bore such that fluid discharge from the first axial bore segment to the second axial bore segment is blocked when the valve sealingly abuts on the valve seat.

12. A pressure relief valve according to claim 8, wherein the shaft end is configured to provide a fluid passage therethrough when the valve is moved into a valve opened position.

13. A pressure relief valve according to claim 12, wherein a stop is defined in the second through-bore for contacting the shaft end when the valve is moved to the valve opened position, the stop having an aperture defined therein so as to be in fluid communication with the fluid passage of the shaft end.

14. A pressure relief valve according to claim 13, wherein the fluid passage is one of slot-shaped and crossed slot-shaped.

15. A fuel injection system comprising:
a common rail and
the pressure relief valve according to claim 14, wherein the first axial bore segment is in fluid communication with high-pressure fuel within the common rail.

16. A fuel injection system comprising:
a common rail and
the pressure relief valve according to claim 8, wherein the first axial bore segment is in fluid communication with high-pressure fuel within the common rail.

17. A method for assembling the pressure relief valve of claim 8, comprising:
inserting at least a portion of the valve into the second axial bore segment of the first housing part,
placing the second through-bore of the second housing part around the shaft of the valve,
securely engaging the shaft end of the valve with a tool, and
screwing the second housing part together with the first housing part while preventing the valve from rotating relative to the first housing part.

18. The method according to claim 17, wherein the tool is a screwdriver and the shaft end has a slot or crossed-slot securely engaged by the screwdriver.
